(19) United States
(12) Patent Application Publication
(10) Pub. No.: US 2020/0211063 A1
(43) Pub. Date: Jul. 2, 2020

(54) SYSTEMS AND METHODS FOR REAL-TIME REVENUE AND COST ATTRIBUTION ASSOCIATED WITH USER ACQUISITION

(71) Applicant: MODE TECHNOLOGIES, INC., New York, NY (US)

(72) Inventor: Mark LEE, Harrisonburg, VA (US)

(21) Appl. No.: 16/728,739

(22) Filed: Dec. 27, 2019

Related U.S. Application Data
(60) Provisional application No. 62/786,163, filed on Dec. 28, 2018.
(60) Provisional application No. 62/786,153, filed on Dec. 28, 2018.

(51) Int. Cl. G06Q 30/02; H04N 21/258

(52) U.S. Cl. CPC G06Q 30/0277; H04N 21/25866; G06Q 30/0247; G06Q 30/0273

(57) ABSTRACT

Embodiments disclosed herein provide for systems and methods of real-time revenue and cost attribution associated with user acquisition on a website page. The system and methods provide for the presentation of real-time analytics at the individual page and user level and allows the backend system to make real-time decisions that can impact profitability per user.

### CROSS-REFERENCE TO RELATED APPLICATION

This application claims the benefit of the filing date of, and incorporates by reference thereto in its entirety, U.S. Provisional Patent Application Ser. Nos. 62/786,153 and 62/786,163, both filed on Dec. 28, 2018.

### TECHNICAL FIELD

The present application relates to a system and method for real-time revenue and cost attribution associated with user acquisition for website pages.

### BACKGROUND

Online advertising is a multi-billion dollar industry. Online advertising has substantial benefits over traditional advertising such as television spots, billboards, magazines, etc. For example, with online advertising, advertisers are able to target their advertisements to users based on information (e.g., user's browser activity as well as any personal information entered by the user at a website) collected and stored by the user's web browser as the user browses a particular website (e.g., “cookies”). However, similar to traditional advertising, it has proven difficult in online advertising to determine the value of a targeted audience. In particular, it is difficult for digital publications to determine whether the user viewing the advertisement actually sees or engages with the advertising, or ignores the advertisement. Currently, digital publications use a combination of reports sourced from different outlets to determine a minimum value to place on their audience. The data available from these reports are typically based on averages across many users, such as: (i) “average” per user, or eCPM (i.e., effective cost per thousand impressions) and (ii) “average” per page view, or RPM (i.e., revenue per thousand impressions). Digital publications also use reporting based on Urchin Tracking Module (UTM) parameters such as source (e.g., which website sent the traffic), content (e.g., determines if the advertisement was a text link, banner ad, etc.), campaign (e.g., type of product campaign), medium (e,g., type of link used), and search terms. However, such reporting is only performed after the user leaves the digital publication's website page. Current solutions do not provide a means for identifying the value of a user in real time so that digital publications can make decisions that affect their key performance indicators (KPIs) while that user is still active on the website page.

Accordingly, there is a need for real-time revenue and cost attribution while a user is still active on a website page.

### SUMMARY OF THE INVENTION

According to an embodiment, the invention relates to systems and methods for real-time revenue and cost attribution associated with user acquisition on a website page.

For example, according to an embodiment, a computer-implemented method for attributing, in real time, a cost associated with acquiring a user to interact with a landing website page to a revenue provided by the acquired user, the method comprising: upon determining that the acquired user has accessed at least one advertisement link on a website page, transmitting the acquired user to a link redirection system, wherein the at least one advertisement link is associated with the landing page; recording, with the link redirection system, information associated with the acquired user and the cost associated with acquiring the user for the landing website page; transmitting the acquired user to the landing website page; upon determining that revenue has been generated by the acquired user on the landing website page, submitting, with an image web service, the information associated with the acquired user and the revenue to a polling web service; and attributing the cost to the revenue based on the information associated with the acquired user while the acquired user remains on the landing website page.

Further, according to an embodiment, system for attributing, in real time, a cost associated with acquiring a user to interact with a landing website page to a revenue provided by the acquired user, the system comprising: one or more processors, wherein the one or more processors are configured to: upon determining that the acquired user has accessed at least one advertisement link on a website page, transmit the acquired user to a link redirection system, wherein the at least one advertisement link is associated with the landing page; record, with the link redirection system, information associated with the acquired user and the cost associated with acquiring the user for the landing website page; transmit the acquired user to the landing website page; upon determining that revenue has been generated by the acquired user on the landing website page, submitting, with an image web service, the information associated with the acquired user and the revenue to a polling web service; and attribute the cost to the revenue based on the information associated with the acquired user while the acquired user remains on the landing website page.

### BRIEF DESCRIPTION OF THE DRAWINGS

FIG. 1A illustrates an example of a revenue reporting system according to an embodiment of the present invention.

FIG. 1B illustrates another example of a revenue reporting system according to an embodiment of the present invention.

FIG. 1C illustrates a flow diagram of an open real-time revenue engine according to an embodiment of the present invention.

FIG. 1D illustrates a real-time workflow example of a UTM cost/revenue summarizer according to an embodiment of the present invention.

FIG. 1E illustrates another real-time workflow example of a UTM cost/revenue summarizer according to an embodiment of the present invention.

FIG. 2A illustrates a system diagram according to an embodiment of the present invention.

FIG. 2B illustrates an example of a link redirection service according to an embodiment of the present invention.

### DESCRIPTION OF EMBODIMENTS

The following description of embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

One aspect of the present disclosure is to provide a system and method for aligning the cost of the acquisition of users to the revenue generated from those same users in real-time. Such information may then be transmitted to the website page and/or a backend system (e.g., associated with the particular website page). This allows for the presentation of real-time analytics at the individual page and user level, and allows the backend system to make real-time decisions that can impact profitability per user. Further, the systems and methods herein address at least one of the problems discussed above.

According to an embodiment, a user may be acquired from a buy-side or demand-side platform user interface. For example, the user interface may provide access to different types of users based on age, interests, locations, etc. An advertiser may then purchase the type or types of users that will be shown the advertising. A short code or link associated with the particular advertisement, which contains all of the information of the cost and the tracking parameters for the advertising campaign, is created and provided to a website page including the advertisement. Then, after the particular user clicks the advertisement link, a cost of the advertisement for the user may be generated and the user may be redirected to a link redirection system. In the link redirection system, user information such as audience ID (e.g., permanent identifier for the user), session ID (e.g., identifier for user's session across one or domains for a specific period of activities), and journey ID (e.g., individual tracking identifier for a specific path acquisition of that user), along with one or more other tracking identifiers are recorded, and, in the background, the system submits a “buy” event including the user information as well as the cost per click (CPC) of the advertisement. The user is then redirected to the linked landing website page including content, such as an article and a number of other advertisements (e.g., third-party advertisements), where a number of activities (e.g., reading the article, viewing the advertisements, clicking on other links on the page, etc.) may be considered and submitted as a “sell” event with an associated revenue pixel (e.g., an image web service that generates and returns an image file, e.g., a .GIF file, when it is called). This “sell” event and the corresponding revenue information can then be associated with the previous “buy” event. The associated revenue information is then processed through another system and can then be sent back to the landing website page via a variety of mechanisms. As a result, the system can track the cost of acquisition and the revenue generated in real time of the individual user, while the user is still on the website page. Further, based on the cost and revenue data, the website page can be modified to at least one of include additional advertisements, remove certain advertisements, change the layout of the currently displayed advertisements, etc. According to an embodiment, the modifications can performed automatically based on a number of triggers associated with the website page (e.g., change/add/remove an advertisement if revenue is greater than or less than a certain value).

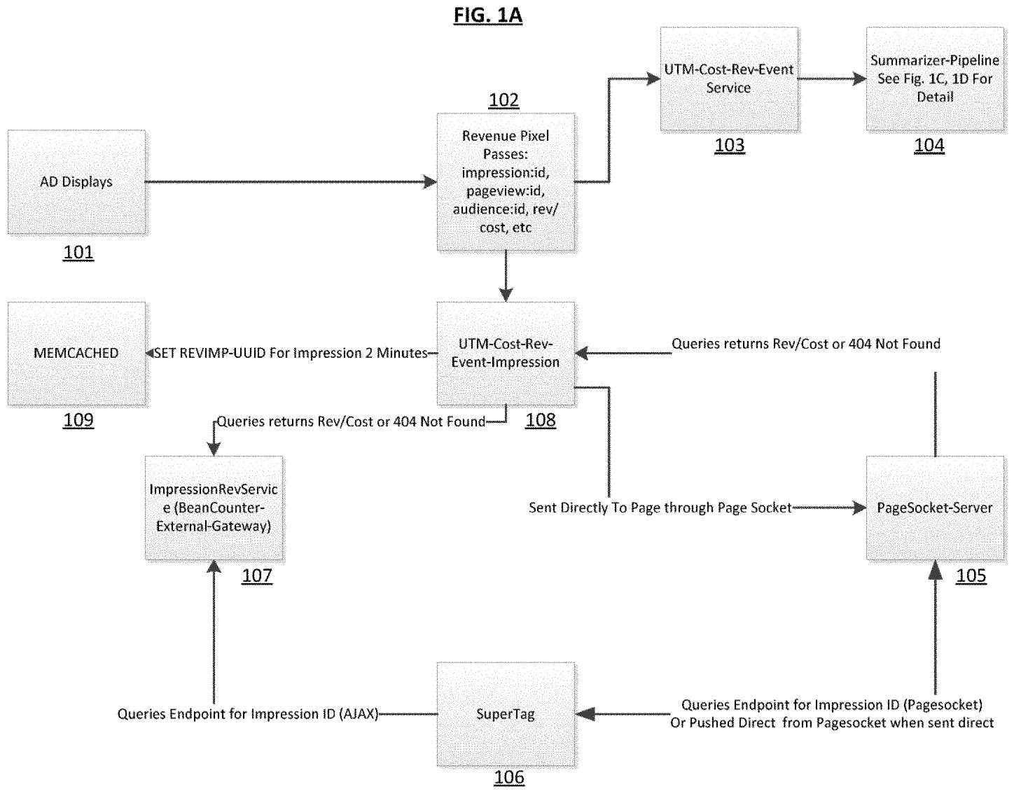

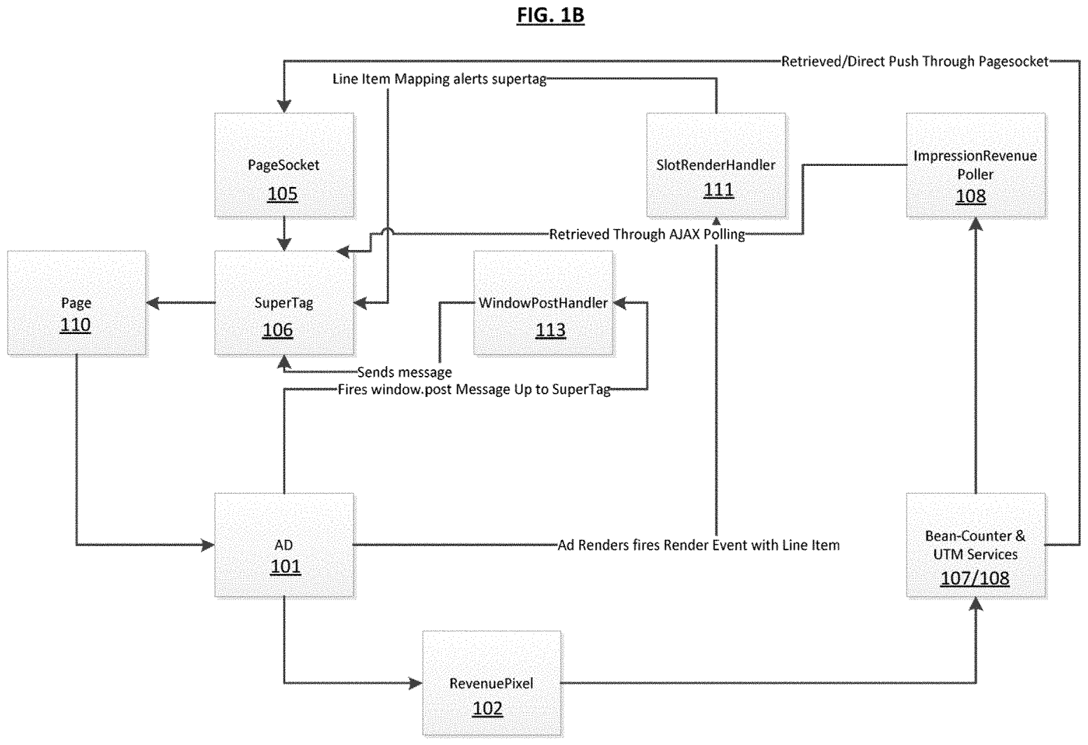

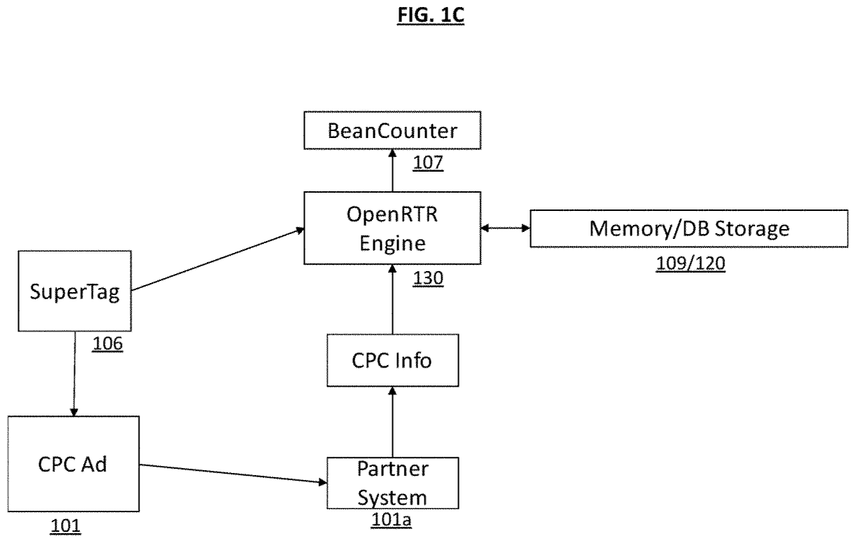

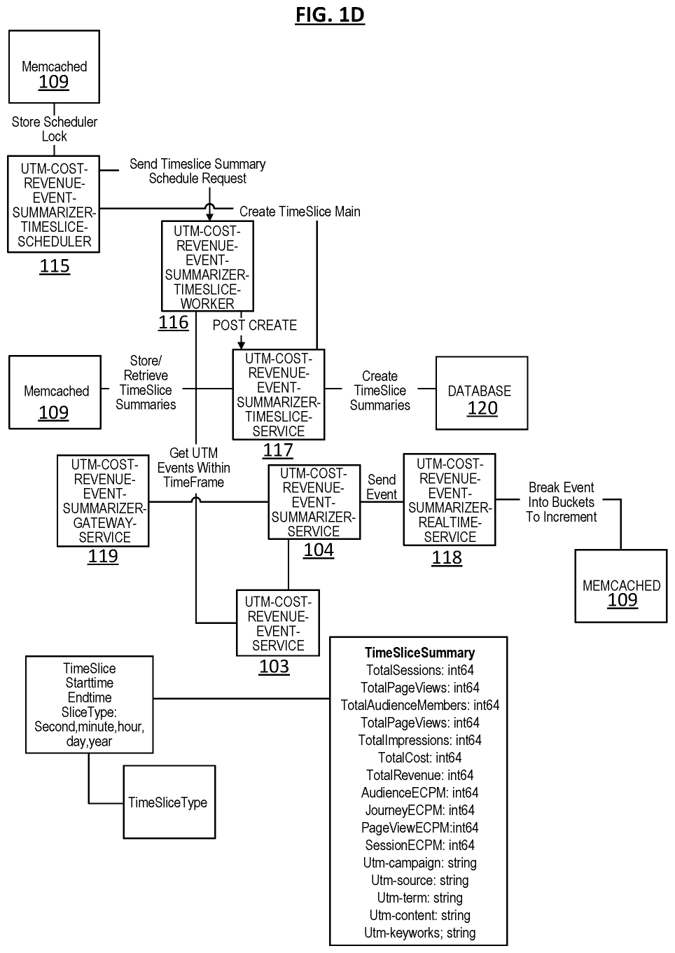

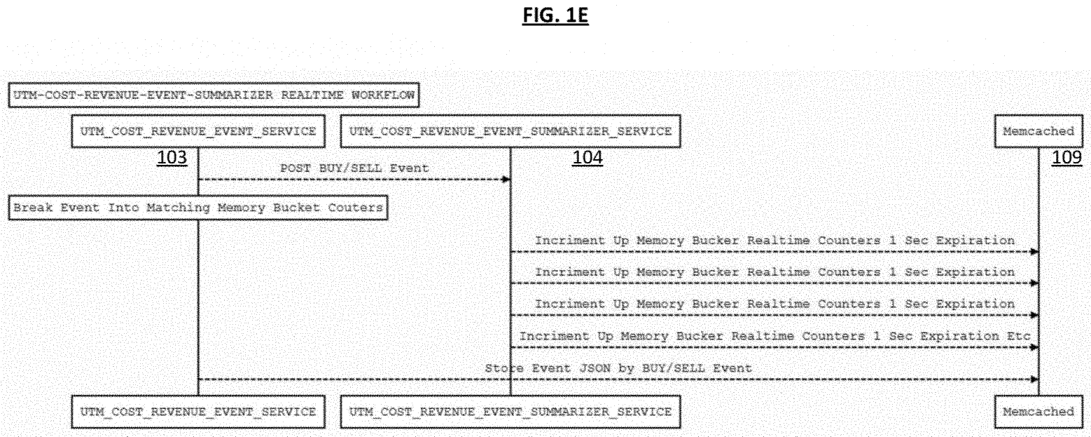

FIG. 1A illustrates an example of a revenue reporting system according to an embodiment of the present invention. As depicted in the figure, the revenue reporting system includes advertisement displays 101, revenue pixel 102, UTM cost/revenue service 103, UTM cost/revenue summarizer service 104, PageSocket server 105, SuperTag 106, impression revenue service (i.e., Bean Counter external gateway) 107, UTM cost/revenue impression 108, and memory cache (or memcached) 109. According to an embodiment, the advertisement display 101 can correspond to a particular advertisement being displayed on a landing website page. Further, assuming a particular revenue event associated with the advertisement display 101 has occurred (e.g., reading the article, viewing/clicking the advertisement display 101, clicking on other links on the page, etc.), the particular advertisement display 101 calls the revenue pixel 102 associated with the landing website page. As described above, the revenue pixel 102 corresponds to an image web service for executing a sell-side alert of the monetization of an item, e.g., a display, page view, action, conversion, or item sell. The revenue pixel 102 then calls the cost/revenue service 103 for storage and summarization. Further, the revenue pixel 102 can also be configured to allow for page view information e.g., page view ID) and impressions information (e.g., impression ID) to be executed for loopback into the PageSocket server 105. According to an embodiment, the PageSocket server 105 is a WebSocket/long poll service that allows for events received from backend systems to be submitted to and received from the landing website page. Further, the PageSocket server 105 consists of a frontend JavaScript code library and a number of backend services with a defined API that allow for events to flow back and forth from the website page allowing for cross-domain communication. In other words, the PageSocket server 105 creates a tunnel to the landing website page, with commands being interpreted and broadcast to various levels of targeting. In particular, a command can be sent that targets a specific page view, audience member, session, or journey, thereby allowing commands from different domains that the user is on simultaneously to be sent, and to instruct and control the pages to perform specific actions triggered by a variety of different mechanisms. The UTM cost/revenue service 103 aligns the cost/revenue to UTM tracking codes along with audience, session, journey, page view, and impression information. The UTM cost/revenue summarizer service 104 tracks summarized data by UTM parameters, journeys, sessions, and audience members. Further, the UTM cost revenue summarizer service 104 will return CPM, total revenue/cost, total impressions, audience sessions, journeys, page views per combination, etc. Further, the summarizer 104 also stores summarized information inside a summary table for permanent storage, which can take place in the background from summarization workers. Further, the UTM cost/revenue impression 108 is called to set the memory cache 109 to the value of the advertisement for calls later querying through the SuperTag 106 via the impression revenue service 107. According to an embodiment, the SuperTag 106 corresponds to a rules engine that tracks a number of activities in the website page, e.g., revenue from an advertisement. In particular, the SuperTag 106 can be a sell-side engine/client JavaScript page engine, where the advertisements can be generated and are selected based on rules, and injected into the landing website page based on the signals sent to the client JavaScript. Further, the SuperTag 106 can be implemented in the landing website page via a short strand of specific code, e.g., JavaScript code, embedded in the landing website page's code. According to an embodiment, with the SuperTag 106, the advertisement display 101 can be displayed without corresponding code in the landing website page's code. Instead, logic associated with the SuperTag 106 can generate the advertisement display 101. Further, the SuperTag 106 can fire additional actions and triggers based on the value of the received revenue associated with a user. Further, the SuperTag 106 can also execute arbitrary commands from the server-side through the PageSocket server 105, which allows information that's not contained within the website page's code to be sent in and out of the landing website page. As such, with the SuperTag 106 and the PageSocket server 105, content can be introduced into the landing website page without the necessity of corresponding code in the landing website page's code.

In other words, after the revenue pixel 102 is called by the advertisement display 101, the revenue pixel 102 can correlate the page view, audience, session, UTM, as well as the amount of money from the “sell” event. Then, the revenue pixel 102 can call the UTM cost/revenue service 103, which stores the sell event and sends it to the summarization pipeline 104. Further, the UTM cost/revenue impression 108 is called at the same time to store information in the memory cache 109 for a period of time (e.g., 2 minutes) so that the information can be directly requested from memory cache 109 by the UTM cost/revenue impression 108 when called from the impression revenue service 107, which in turn returns the sell event back to the landing website page through an AJAX call to the SuperTag 106. As such, the SuperTag 106 can correlate the revenue to the active website page view. FIG. 1B illustrates another example of a revenue reporting system according to an embodiment of the present invention. For example, if a particular revenue event associated with the advertisement display 101 has occurred on the landing website page 110 (e.g., reading an article, viewing/clicking the advertisement display 101, clicking on other links on the website page, etc.), the associated revenue information can be processed and sent back to the website page 110 via the SuperTag 106 associated with website page code and a variety of different mechanisms. For example, the PageSocket 105 can fire the revenue information as a JSON call inside the WebSocket into the system to record the revenue. In addition, the revenue information can also flow back to the website page 110 through PageSocket 105. Further, with the slot render handler 111, the identifier for the advertisement display 101 being rendered can be matched to a specific monetary value, along with any additional information that's needed for recording it. Further, with the window post handler 113, a window.postmessage event can be fired on the iframe from the advertisement display 101 so that it can tunnel out to the website page 110 where the advertisement display 101 is being rendered. As such, the website page 110 is able to “listen” to the message from the advertisement display 101 and record the revenue. In addition, as depicted in the figure, all of the above mechanisms trigger a flow into the Bean Counter 107/UTM services 108, which keeps track of the recorded record of the revenue. The Bean Counter 107/UTM services 108 can then send that information to the PageSocket 105, where it submits the information back to the website page 110 that generated the revenue, so that the revenue can be recorded at the page.

FIG. 1C illustrates a flow diagram of an open real-time revenue engine according to an embodiment of the present invention. With an open real-time revenue (OpenRTR) engine, if a revenue event happens asynchronously, e.g., sometime after the fact, it can still be associated with the initial user interaction with the advertisement display. OpenRTR is a specification for an open interchange standard of revenue information. With OpenRTR, various sell/buy partners can be related to each other via correlation IDs and combined to allow for a push/pull architecture to sync costs and revenues across distributed systems. This is accomplished by implementing a correlation ID of transactions across partners that can be submitted back and forth across systems to glue together different parameters and matchups for a unified view of what happens from a buy/sell perspective. For example, an OpenRTR correlation ID of 12344567 can internally map to audience: 1234, session: 1234, journey: 1234, page view: 1234, which can be sent over to a sell-side partner when called. In response, the partner fires back at the OpenRTR endpoint correlation ID: 12344567 and the event that took place, i.e., sell: cpm 5, which can trigger logging and internal events into the system from. On the buy side, another partner executes a correlation ID on the page landing that is then passed and mapped to internal values, thereby closing the loop from the buy side. As such, if an action that generates revenue occurs after the user has left the website page, the initial event that took place and the time period that it happened can still be generated using the correlation ID. For example, as depicted in the figure, the SuperTag 106 generates a correlation ID for a particular advertisement display 101 and submits the correlation ID to an OpenRTR engine 130 for later attribution. The OpenRTR engine 130 then stores the correlation ID with a universal unique identifier (UUID) in either the memory cache 109 or a database 120 (e.g., for longer term storage than the memory cache 109). Then, assuming the advertisement display 101 is clicked at a later time, the advertisement display 101 sends the corresponding correlation ID and revenue information, e.g., via click transfer, to the third-party partner system 101a which is associated with the advertisement display 101. In this regard, the partner system 101a can be the advertiser behind the advertisement display 101. The partner system can then provide the correlation ID, the revenue information (e.g., CPC), along with other partner-specific information, to the OpenRTR engine 130. The OpenRTR engine 130 can then retrieve previously-stored information using the correlation ID and transmit the previously-stored information and the partner-provided information to the Bean Counter 107. As such, if the user is acquired again, the system can generate an appropriate user experience reflective of the user's increased value to the website page's owner, e.g., by generating fewer advertisement displays 101 on the website page 110.

According to an embodiment, the OpenRTR engine 130 may include an OpenRTR application program interface (API) service, a revenue (sell) pixel, a cost (buy) pixel, a correlation service, a UTM cost/revenue service, and a UTM cost/revenue summarizer service. The OpenRTR API service is a representational state (RESTful) API service that implements the OpenRTR specification for http(s) endpoints. The revenue pixel corresponds to an image web service for executing a sell-side alert of the monetization of an item, e.g., a display, page view, action, conversion, or item sell. The revenue pixel may be modified to allow for page views (e.g., via page view ID) and impressions (e.g., via impression ID) to be executed for loopback into the PageSocket service. Further, according to an embodiment, the buy pixel corresponds to an image web service for executing a buy-side alert of the monetization of an item, e.g., a display, page view, action, conversion, or item buy. The correlation service aligns different UUIDS from partners. The UTM cost/revenue service aligns the cost/revenue to UTM tracking codes along with audience, session, journey, page, and impression information. The UTM cost/revenue summarizer service tracks summarized data by UTM parameters, journeys, sessions, and audience members. Further, the UTM cost/revenue summarizer service will return CPM, total revenue/cost, total impressions, audience sessions, journeys, page views per combination, etc. Further, the summarizer also stores summarized information inside a summary table for permanent storage, which can take place in the background from summarization workers.

According to an embodiment, the UTM cost/revenue summarizer service is utilized with the help of a unified time management system, i.e., timeslice. Timeslice creates “slices” of time as well as a unified ID that is used to combine multiple summarization services together to an exact period of time, because the summarization varies greatly based on the duration of time measured. For example, a timeframe may consist of the following values:

time period 1: [a, b]=2 unique units,

time period 2: [b, c]=2 unique units,

time period 3: [d, b, e]=3 unique units, and

time period 4: [d, b, e, f]=4 unique units.

According to an embodiment, if the values of time period 1 and time period 2 were taken together as a duration (timeslice), the unique count would be 3. However, if the two time periods were added together, the unique count would be 4, which is incorrect. Further, if all 4 periods were added together, there would be 11 unique units. However, if all of the time periods were taken together into a timeslice of duration of period 1-4, the unique count would be 6. The timeslice service allows for the unification of the various durations of time to align various summarizations together into discrete periods of time to get the closest, most accurate result (if a timeslice is available of the specific duration), or to get the largest periods of summarization available to get the closest approximation across many different services and summarizations.

Methods for providing real time and summarized data are shown in FIGS. 1D and 1E. A buy event may be triggered from a link click through link redirector or redirection service/system, this would emit a “buy” event from the system to the UTM cost/revenue event service, which would then store the corresponding audience ID, session ID, journey ID, page view ID, cost, and UTM tracking information. When sell events take place through the revenue pixel 102, those would in turn call the UTM cost/revenue event service 103 which would log the sell event with the same information. Further, as depicted in FIG. 1D, the UTM cost/revenue event service 103 can store this information and hash together the different values for fast lookup for future summarization and normalization. This information can then get written to the database 120 (e.g., for longer term storage than the memory cache 109) from the UTM cost/revenue event service 103. Further, each of these events are sent over to the UTM cost/revenue event summarizer service 104, which in turn sends the events to the UTM cost/revenue event summarizer real-time-service 118. The real-time service 118 separates the received events into various “buckets” based on the hashes available e.g., UTM campaign, session, audience, etc. Each bucket has a buy/sell target that gets incremented with the received values and has short time memory storage to provide real-time summaries for requests where a timeslice summary has not yet been generated. Further, according to an embodiment, requests for getting a summary are handled via the UTM cost/revenue event summarizer gateway service 119, which directs either a request for getting the information from the real-time or timeslice summarization services based on the period of time selected.

Further, the UTM cost/revenue summarizer timeslice service 117 creates and retrieves the summarizations from the UTM cost/revenue event summarization timeslice worker 116, which retrieves timeslice schedule calls from UTM cost revenue event summarizer timeslice-scheduler 115 and distributes the work out to the timeslice workers at specified intervals.

FIG. 1E illustrates a request for the real-time workflow. When running a highly-distributed and high transaction system, understanding what is happening in the moment is difficult. Due to the I/O bound limitations of querying the database for certain data, real-time memory counters are stored so that the system can be accurate to what is happening at the specific periods of time prior to the “write” taking place at the long term data storage layer. Further, the event components are separated into various buckets of counters for the different components with short time expirations to provide the real-time diagnostics of what is taking place without having to wait for the I/O to occur at the database layer. This provides for real-time metrics as well as the handling of large volumes of transactions.

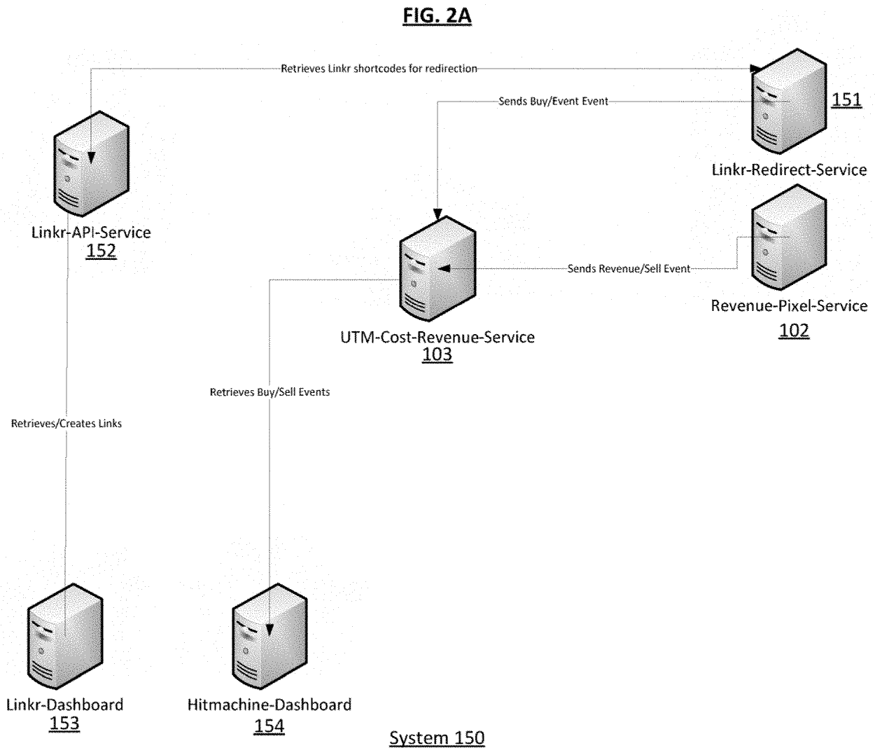

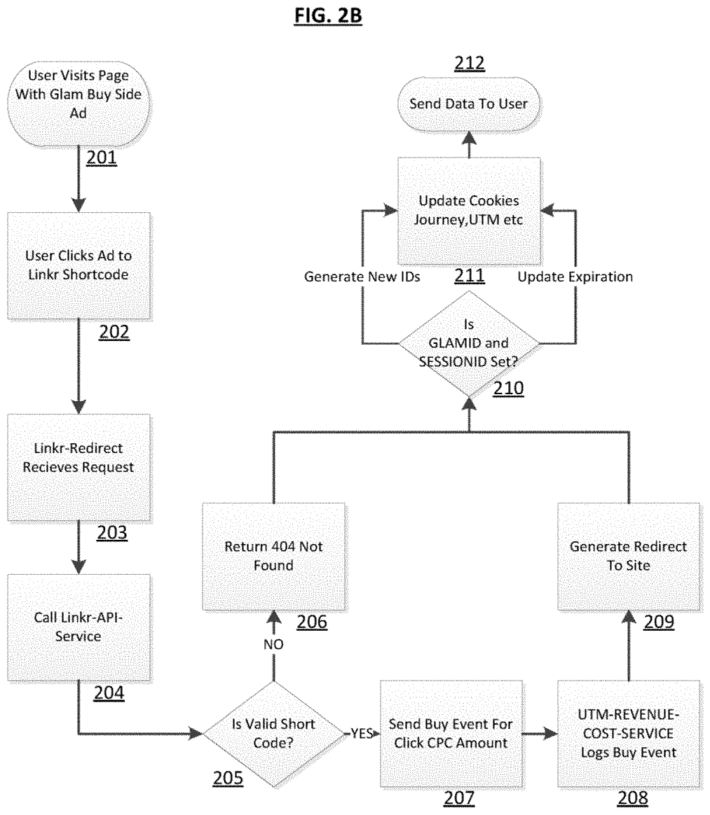

FIG. 2A illustrates a system diagram according to an embodiment of the present invention. As depicted in the figure, the system 150 includes the revenue pixel service 102, the UTM cost/revenue service 103, a link redirection service (“Linkr”) 151, a Linkr API service 152, a Linkr dashboard 153, and a Hitmachine dashboard 154. According to an embodiment, the Hitmachine dashboard 154 is a buying system that uses feedback to make automated decisions on buying users. In particular, the Hitmachine dashboard 154 uses various methods of machine-learning and genetic algorithms to optimize the buy of the users; buying system that uses feedback system to make automated decision on buying users. According to an embodiment, the Linkr redirector service 151, the Linkr API service 152, and the Linkr dashboard 153 form a total Linkr service. For example, the Linkr redirector service 151 handles requests for short codes, and communicates to the Linkr API service 152 to get the redirection target and emit the UTM-cost/revenue service 103 events for the Hitmachine dashboard 154 and set the initial cookies for audience, session, journey, UTM, and CPC. Further, according to an embodiment, the Linkr API service 152 exposes a RESTful interface for the CRUD (i.e., create, retrieve, update, and delete) of Linkr objects and Linkr events. The Linkr objects contain a short code, cost per redirection (CPC), and an end point to send to.

According to an embodiment, as soon as the Linkr service receives a request, a cost UTM with the audience information is provided to the UTM cost/revenue service 103. The Linkr service will then transmit the information contained within the cookies prior to redirect to the audience service, and generate any missing information as well as set the ownership down for the audience tracking service. The Linkr service will then update the cookie for the browser prior to the redirect.

On the website page itself, the SuperTag 106 receives the redirection data to store the audience ID (e.g., glam ID), session, cost for redirection, etc. for transmitting back to the system. In particular, the SuperTag 106 generates and stores a page view ID, and transmits that back out to the system to associate it back to the audience ID. SuperTag 106 sets on the publication function of Google Publisher Tag (GPT) or the like, the key/value (k/v) for the page view ID, audience ID, etc. Further, for each specific SLOT inside of GPT, the SuperTag 106 will generate an impression ID, impression opportunity ID (e.g., corresponding to advertisements that had a possibility of an impression but didn't get any actual impressions), and an impression display ID, which will be associated to the specific advertisement slot k/v pairs. Further, when the call for refresh is transmitted, those generated values can go to DoubleClick for Publishers (DFP) or the like, and will be associated to the revenue pixel call. As such, the information that is needed to associate the individual impression, opportunity, and display can then be stored.

The SuperTag 106 can then long poll a JSON endpoint for the impression ID for a response on the CPM. This would require the UTM cost/revenue service 103 to push to a queue, or, at a minimum, set a memory cache value for the service to query for the result for the impression ID that the endpoint would be listening for, and, once received, return the information needed. The SuperTag 106 would then update its internal record of the revenue for the user. SuperTag 106 would then compare that revenue number with the cost number until it reaches profitability, at which point it would need to execute a pixel fire with buy-side partners to put them into a group for future acquisition.

FIG. 2B illustrates an example of a link redirection service according to an embodiment of the present invention. As depicted in the figure, in a first step 201, a user visits a page with a particular buy-side advertisement. Then, in step 202, a user clicks an advertisement and, therefore, a request for a short code is initiated. Then, in step 203, the Linkr redirector service 151 receives the short code request. Then, in step 204, the Linkr redirector service 151 communicates the short code request to the Linkr API service 152. Then, in step 205, it is determined whether the short code is valid. If the short code is not valid, an error message is returned, e.g., “404 Not Found.” Otherwise, the method proceeds to step 207, where a buy event for the click CPC amount is sent. Then, in step 208, the UTM cost/revenue service logs the buy event. Then, in step 209, a redirect to the site is generated. Further, according to an embodiment, as depicted in the figure, the method proceeds to step 210 after step 206 or step 209. In step 210, it is determined if the audience ID and session ID are set. After which, new IDs are generated and the expirations are updated in order to update the cookies, journey, UTM, etc. as depicted in step 211. Lastly, in step 212, the data is sent to the user.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., pan FPGA (field programmable gate array) or an ASIC (application specific integrated circuit).

In the foregoing Description of Embodiments, various features may be grouped together in a single embodiment for purposes of streamlining the disclosure. This method of disclosure is not to be interpreted as reflecting an intention that the claims require more features than are expressly recited in each claim. Rather, as the following claims reflect, inventive aspects lie in less than all features of a single foregoing disclosed embodiment. Thus, the following claims are hereby incorporated into this Description of Embodiments, with each claim standing on its own as a separate embodiment of the invention.

Moreover, it will be apparent to those skilled in the art from consideration of the specification and practice of the present disclosure that various modifications and variations can be made to the disclosed systems without departing from the scope of the disclosure, as claimed. Thus, it is intended that the specification and examples be considered as exemplary only, with a true scope of the present disclosure being indicated by the following claims and their equivalents.

1. A computer-implemented method for attributing, in real time, a cost associated with acquiring a user to interact with a landing website page to a revenue provided by the acquired user, the method comprising:
upon determining that the acquired user has accessed at least one advertisement link on a website page, transmitting the acquired user to a link redirection system, wherein the at least one advertisement link is associated with the landing page;
recording, with the link redirection system, information associated with the acquired user and the cost associated with acquiring the user for the landing website page;
transmitting the acquired user to the landing website page;
upon determining that revenue has been generated by the acquired user on the landing website page, submitting, with an image web service, the information associated with the acquired user and the revenue to a polling web service; and
attributing the cost to the revenue based on the information associated with the acquired user while the acquired user remains on the landing website page.

2. The method of claim 1, further comprising:
calling the image web service, wherein the image web service generates an image file in response to being called.

3. The method of claim 2, wherein the image file is a GIF file.

4. The method of claim 1, further comprising:
providing at least one of the cost and the revenue to the landing website page; and
modifying the landing website page based on at least one of the cost and the revenue, wherein the modifying includes one of (i) adding at least one advertisement display to the landing website page or (ii) removing the at least one advertisement display from the landing website page.

5. The method of claim 1, wherein the revenue can be monitored on the landing website page via a rules engine, wherein the rules engine is implemented as particular code in the landing website page's code.

6. The method of claim 5, wherein the particular code is JavaScript code.

7. The method of claim 5, wherein the rules engines generates and provides at least one advertisement display to the landing website page based on rules.

8. The method of claim 1, wherein the information associated with the acquired user includes at least one of audience information, session information, and journey information.

9. A system for attributing, in real time, a cost associated with acquiring a user to interact with a landing website page to a revenue provided by the acquired user, the system comprising:
one or more processors, wherein the one or more processors are configured to:
upon determining that the acquired user has accessed at least one advertisement link on a website page, transmit the acquired user to a link redirection system, wherein the at least one advertisement link is associated with the landing page;
record, with the link redirection system, information associated with the acquired user and the cost associated with acquiring the user for the landing website page;
transmit the acquired user to the landing website page;
upon determining that revenue has been generated by the acquired user on the landing website page, submitting, with an image web service, the information associated with the acquired user and the revenue to a polling web service; and
attribute the cost to the revenue based on the information associated with the acquired user while the acquired user remains on the landing website page.

10. The system of claim 9, wherein the one or more processors are further configured to:
call the image web service, wherein the image web service generates an image file in response to being called.

11. The system of claim 10, wherein the image file is a GIF file.

12. The system of claim 9, wherein the one or more processors are further configured to:
provide at least one of the cost and the revenue to the landing website page; and
modify the landing website page based on at least one of the cost and the revenue, wherein the modifying includes one of (i) adding at least one advertisement display to the landing website page or (ii) removing the at least one advertisement display from the landing website page.

13. The system of claim 9, wherein the revenue can be monitored on the landing website page via a rules engine, wherein the rules engine is implemented as particular code in the landing website page's code.

14. The system of claim 13, wherein the particular code is JavaScript code.

15. The system of claim 13, wherein the rules engines generates and provides at least one advertisement display to the landing website page based on rules.

16. The system of claim 9, wherein the information associated with the acquired user includes at least one of audience information, session information, and journey information.
